(19) United States
(12) Patent Application Publication
(10) Pub. No.: US 2026/0222102 A1
(43) Pub. Date: Jul. 30, 2026

(54) CONFIGURING CARRIER SELECTION

(71) Applicant: Telefonaktiebolaget LM Ericsson (PUBL), Stockholm (SE)

(72) Inventors: Sergio Mosti, Genova (IT); Alberto Deho, Genova (IT); Claudio D’incà, Genova (IT); Roberto Magri, Genova (IT)

(21) Appl. No.: 19/145,457

(22) PCT Filed: Jan. 5, 2023
(86) PCT No.: PCT/EP2023/050156

§ 371 Date: Jul. 2, 2025

(51) Int. Cl. H04J 14/02; H04B 10/80

(52) U.S. Cl. CPC H04J 14/0227; H04B 10/806

(57) ABSTRACT

In an embodiment, apparatus (100) for configuring carrier selection from a wavelength-division multiplexed, WDM, signal (102) comprising a plurality of carriers is described. The apparatus comprises an optical interface (104). The optical interface is configured to receive the WDM signal and an optical control signal (106). The apparatus further comprises a switch (108). The switch is actuatable in response to an electrical control signal (110) to control carrier selection according to whether the switch is to pass a carrier of the WDM signal. The apparatus further comprises control circuitry (112). The control circuitry is configured to: convert optical power of the optical control signal to electrical power for powering the apparatus, wherein the optical control signal is encoded with control information for controlling the switch; generate the electrical control signal based on the control information; and provide the electrical control signal to the switch.

### TECHNICAL FIELD

The present disclosure relates to configuring carrier selection, and in particular to a method and apparatus for configuring carrier selection from a wavelength-division multiplexed (WDM) signal comprising a plurality of carriers, a method and controller for controlling a configuration of the apparatus, and a system comprising the apparatus and controller.

### BACKGROUND

Optical fronthaul solutions such as based on Wavelength Division Multiplexing (WDM) technology and Dense Wavelength Division Multiplexing (DWDM) technology may be deployed to support Radio Access Network (RAN) connectivity in, for example, Fifth Generation (5G) enabled networks. Fixed filters and tunable filters may be provided in conjunction with such optical fronthaul solutions.

Current technology available for filtering signals includes fully passive fixed filters (that filter a specified wavelength band) and electrically controlled tunable filters that are not considered to be passive. Fully passive fixed filters need manual configuration by performing an appropriate optical patch-cord connection. Tunable filters need a power connection and a connection to a network manager that selects channels based on predetermined bandwidth allocation.

In some cases, fixed filters may be the preferred solution due to the simplicity of a passive installations in unmanaged locations. However, this solution requires many variants with considerable inventory management needed to support the optical fronthaul deployment.

In some cases, tunable filters may be the preferred solution from a network point of view given the flexibility provided and the possibility to reduce the number of variants of fixed filter deployments to be used in the current network. The current trend is to increase flexibility in the optical layer even in the near-RAN transport segment. Such flexibility can be provided by tunable filters with an external electrical power source. Currently, the technology for tunable filters needs to be hosted into a managed network element requiring both power and a management connection, which decreases deployment flexibility and increases the cost of deployment.

### SUMMARY

Certain aspects and embodiments described herein may provide a low-cost passive solution for enabling tunable filter technology while reducing or obviating problems with existing solutions.

According to a first aspect of the present disclosure, there is provided apparatus for configuring carrier selection from a wavelength-division multiplexed, WDM, signal comprising a plurality of carriers. The apparatus comprises an optical interface. The optical interface is configured to receive the WDM signal and an optical control signal. The apparatus further comprises a switch. The switch is actuatable in response to an electrical control signal to control carrier selection according to whether the switch is to pass a carrier of the WDM signal. The apparatus further comprises control circuitry. The control circuitry is configured to convert optical power of the optical control signal to electrical power for powering the apparatus. The optical control signal is encoded with control information for controlling the switch. The control circuitry is further configured to generate the electrical control signal based on the control information. The control circuitry is further configured to provide the electrical control signal to the switch.

According to a second aspect of the present disclosure, there is provided a controller for controlling a configuration of an apparatus for configuring carrier selection from a wavelength-division multiplexed, WDM, signal comprising a plurality of carriers. The controller is configured to generate an optical control signal for receipt by the apparatus. The optical control signal is configured to allow the apparatus to convert optical power of the optical control signal to electrical power for powering the apparatus. The optical control signal is encoded with control information for controlling a switch of the apparatus to control carrier selection according to whether the switch is to pass a carrier of the WDM signal through the switch.

According to a third aspect of the present disclosure, there is provided a system. The comprises the apparatus of the first aspect and the controller of the second aspect.

According to a fourth aspect of the present disclosure, there is provided a method of configuring carrier selection from a wavelength-division multiplexed, WDM, signal comprising a plurality of carriers. The method comprises receiving the WDM signal and an optical control signal. The method further comprises converting optical power of the optical control signal to electrical power for powering an apparatus comprising a switch. The switch is actuatable in response to an electrical control signal to control carrier selection according to whether the switch is to pass a carrier of the WDM signal. The optical control signal is encoded with control information for controlling the switch. The method further comprises generating the electrical control signal based on the control information. The method further comprises providing the electrical control signal to the switch.

According to a fifth aspect of the present disclosure, there is provided a method of controlling a configuration of an apparatus for configuring carrier selection from a wavelength-division multiplexed, WDM, signal comprising a plurality of carriers. The method comprises generating an optical control signal for receipt by the apparatus. The optical control signal is configured to allow the apparatus to convert optical power of the optical control signal to electrical power for powering the apparatus. The optical control signal is encoded with control information for controlling a switch of the apparatus to control carrier selection according to whether the switch is to pass a carrier of the WDM signal through the switch.

Certain embodiments of the present disclosure may provide one or more of the following technical benefits. Certain embodiments may facilitate the functionality of a tunable filter for filtering a WDM signal without the need for a direct electrical power and network management connection. Such embodiments may be considered to be fully passive solutions and therefore may be straightforward and/or relatively low cost to deploy in a variety of locations while also providing flexible tunable filter functionality. Further, certain embodiments described herein may be constructed using available and mature subcomponents and do not need to rely on more expensive and/or unproven technologies. Further, certain embodiments described herein may have a form factor that is compatible with existing solutions and therefore can be readily integrated with existing optical fronthaul infrastructure.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 is a schematic diagram illustrating an apparatus for configuring carrier selection from a WDM signal according to an embodiment.

FIG. 2 is a schematic diagram illustrating an apparatus for configuring carrier selection from a WDM signal according to an embodiment.

FIG. 3 is a schematic diagram illustrating an apparatus for configuring carrier selection from a WDM signal according to an embodiment.

FIG. 4 is a schematic diagram illustrating a system comprising an apparatus and a controller for controlling a configuration of the apparatus according to an embodiment.

FIG. 5 is a flowchart of a method of configuring carrier selection from a WDM signal according to an embodiment.

FIG. 6 is a flowchart of a method of controlling a configuration of an apparatus for configuring carrier selection from a WDM signal according to an embodiment.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

As already discussed, existing solutions for providing filtering of WDM and DWDM signals fall into two types of solutions. One of these solutions is based on fixed filter technology that is considered to be passive but inflexible. The other of these solutions is based on electrically controlled tunable filter technology that is more flexible than the fixed filter technology. However, such tunable filter technology cannot be considered to be passive nor cheap.

Hence, there is a need to provide a low-cost passive solution for enabling tunable filter technology while reducing or obviating problems with existing solutions.

Certain embodiments described herein may offer a solution to one or more of the problems highlighted herein.

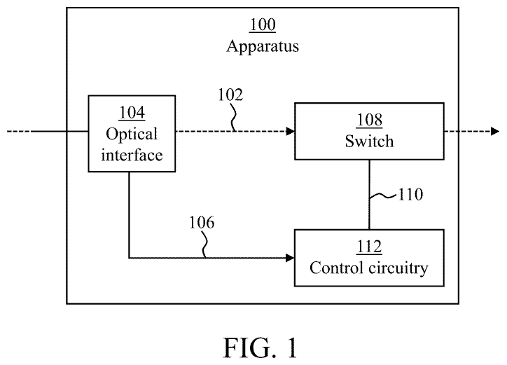

FIG. 1 is a schematic diagram illustrating an apparatus 100 for configuring carrier selection from a WDM signal 102 according to an embodiment. The WDM signal 102 (such as a Dense WDM (DWDM) signal) comprises a plurality of carriers. Each carrier may be provided in a dedicated wavelength band to support the multiplexing of the plurality of carriers for the WDM signal 102. The apparatus 100 may be a telecommunications network node, for example a node for a fronthaul optical network.

The apparatus 100 comprises an optical interface 104.

The optical interface 104 is configured to receive the WDM signal 102 and an optical control signal 106. A distinction between the WDM signal 102 and the optical control signal 106 is shown in the figure by virtue of a dashed line for the WDM signal 102 and a solid line for the optical control signal 106. In use, the optical interface 104 receives and, in some cases, separates both the WDM signal 102 and the optical control signal 106 and directs each respective signal 102, 106 towards the entities described below.

Some possible implementations of the optical interface 104 are described in more detail below.

The apparatus 100 further comprises a switch 108.

The switch 108 is actuatable in response to an electrical control signal 110 to control carrier selection according to whether the switch 108 is to pass a carrier of the WDM signal 102.

The apparatus 100 may control whether (or not) the switch 108 is to pass a carrier (e.g., where the carrier has a dedicated switch 108). That is, the switch 108 may or may not allow the carrier to pass through the switch 108 in dependence on the effect of the electrical control signal 110 on the switch 108. The electrical control signal 110 may actuate the switch 108 to either allow the carrier to pass or prevent the carrier from passing through the switch 108. In this manner, the apparatus 100 may be considered to provide the functionality of a tunable filter since a carrier may or may not be passed by the appropriate control of the switch 108.

Some possible implementations of the switch 108 are described in more detail below.

The apparatus 100 further comprises control circuitry 112.

The control circuitry 112 is configured to convert optical power of the optical control signal 106 to electrical power for powering the apparatus 100. Thus, some power that is in optical form may be converted to electrical power in order to power the apparatus 100. By way of example, such an optical-to-electrical power conversion may be facilitated by a semiconductor device such as a photovoltaic cell. The electrical power extracted from the optical power may be used for several purposes by the apparatus 100. In some cases, the extracted electrical power may be used to charge an energy storage such as a battery or capacitor. In some cases, the extracted electrical power may be used to power the control circuitry 112 itself. In some cases, the extracted electrical power may be used to power the switch 108.

The optical control signal 106 is encoded with control information for controlling the switch 108. Thus, the optical control signal 106 provides power for the apparatus 100 as described above and also includes control information via its encoding. In some cases, the control information may be indicative of whether the switch 108 is to be actuated.

The control circuitry 112 is further configured to generate the electrical control signal 110 based on the control information. The control information may indicate the electrical control signal 110 that is to be generated. For example, the encoding may comprise a first code in the optical control signal 106 to indicate that the switch 108 is to pass the carrier, or the encoding may comprise a second code in the optical control signal 106 to indicate that the switch 108 is not to pass the carrier. Thus, depending on the encoding, the switch 108 may be configured to either pass or not pass the carrier. In a possible implementation, the control circuitry 112 may comprise logic or have access machine-readable instructions which, when implemented by a processor of the control circuitry 112, instruct the control circuitry 112 to interpret the control information to determine whether the switch 108 is to pass the carrier based on the control information. As a result of this determination, the control circuitry 112 may generate the electrical control signal 110 according to the logic or machine-readable instructions.

The control circuitry 112 is configured to provide the electrical control signal 110 to the switch 108. Thus, in response to the electrical control signal 110, the switch 108 may be actuated to control carrier selection according to whether the switch 108 is to pass a carrier of the WDM signal 102.

The apparatus 100 and related embodiments may provide the functionality of a tunable filter for filtering a WDM signal comprising a plurality of carriers without the need for a direct electrical power and network management connection. Some tunable filters require an external electrical power source to operate. However, converting optical power provided by the optical control signal 106 to electrical power for use by the apparatus 100 may avoid the need for a dedicated external source of electrical power. Some tunable filters require a manual reconfiguration by performing the appropriate optical patch-cord connection. However, the optical control signal 106 may facilitate a remote reconfiguration of the apparatus 100 to controllably specify which carriers of the WDM signal 102 are to be passed, and which carriers are to be attenuated or blocked.

Thus, the apparatus 100 and related embodiments may be considered to be fully passive solutions and therefore may be straightforward and/or relatively low cost to deploy in a variety of locations while also providing flexible tunable filter functionality. The apparatus 100 and related embodiments may be constructed using available and mature subcomponents and do not need to rely on more expensive and/or unproven technologies. Further, the apparatus 100 and related embodiments may have a form factor that is compatible with existing solutions and therefore can be readily integrated with existing optical fronthaul infrastructure.

Thus, the apparatus 100 and related embodiments may provide a low-cost passive solution for enabling tunable filter technology while reducing or obviating problems with existing solutions.

Some embodiments relating to the apparatus 100 of FIG. 1 are now described.

In some embodiments, the WDM signal 102 and optical control signal 106 may each be received via an optical input (not shown) such as a fiber optic coupler dedicated to each respective signal 102, 106. Such an arrangement may be used where each signal 102, 106 is transmitted via separate optical fibers.

In some embodiments, the WDM signal 102 and optical control signal 106 may be received via a common input to the optical interface 104. In this case, the optical interface 104 may comprise any appropriate optical element to separate the WDM signal 102 and optical control signal 106. For example, the optical interface 104 may be configured to spectrally filter the WDM signal 102 and optical control signal 106 if they do not have overlapping spectral content.

In some embodiments, the switch 108 has a first state and a second state. In the first state, the switch 108 is configured to prevent the carrier from passing the switch 108. In the second state, the switch 108 is configured to permit the carrier to pass the switch 108. In the first state, the switch 108 may exhibit a high attenuation to prevent or substantially prevent the carrier from passing the switch 108. In the second state, the switch 108 may exhibit a low attenuation to allow or substantially allow the carrier to pass the switch 108.

In some embodiments, in use of the apparatus 100, no electrical power is consumed by the switch 108 when in the first state or the second state. However, electrical power is consumed by the switch 108 when switching between the first and second states.

In some embodiments, the switch 108 comprises a latched switch such as a micromechanical latched (optical) switch. Latched switches may be considered to be passive in the sense that they do not require power once their state is set. Only very low power is required during state change. Latched switches may also provide low optical insertion loss for efficient passing of the carriers.

In some embodiments, the electrical power is derived from a continuous wave (CW) component of the optical control signal 106. A low-speed signal overlay may encode the control information on the CW component of the optical control signal 106. That is, the optical control signal 106 may comprise a CW component, and an encoded/modulated component comprising the control information. Such an encoded/modulated component may have a (low) bit rate that is sufficient to indicate to the control circuitry 112 whether the switch 108 is to be actuated in a timescale that is appropriate for active management of the tunable filter functionality under the control plane. The control plane may not need to implement a fast bit rate because network configuration may be performed at network setup or during topology changes. Further, having a low bit rate signaling allows for the use of an inexpensive transmitter and receiver (and associated circuitry for modulating and recovering transmitted information).

Some further embodiments related to the apparatus 100 are now described.

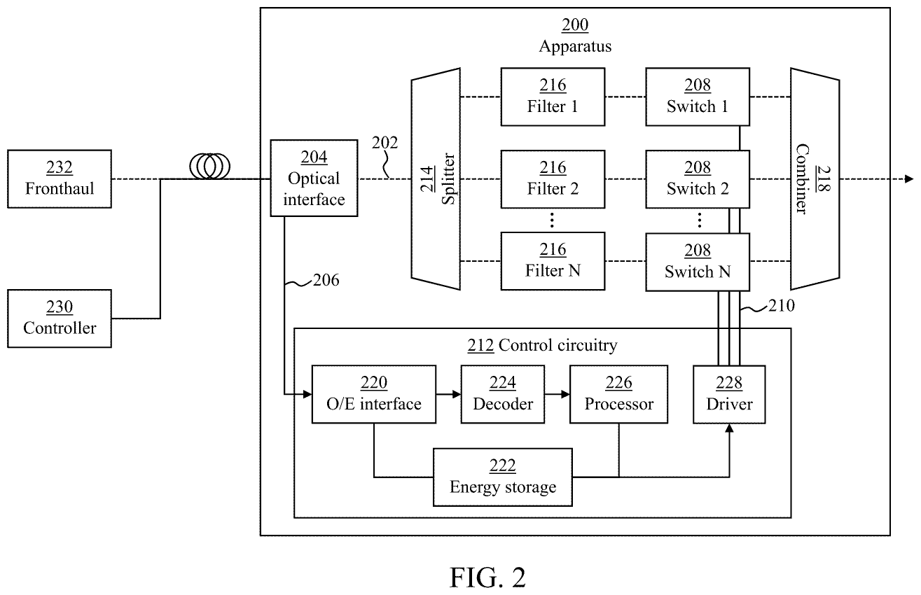

FIG. 2 is a schematic diagram illustrating an apparatus 200 for configuring carrier selection from a WDM signal 202 according to an embodiment. Reference signs for features of the apparatus 200 that are like or similar to corresponding features of the apparatus 100 are incremented by 100. A detailed description of such features is not provided for brevity. Further features and functionality of the apparatus 200 are described in more detail below. Apparatus 220 may be a telecommunications network node, such as, for example, a fronthaul network node.

The apparatus 200 comprises a plurality of switches 208 (numbered 1, 2, . . . , N). The plurality of switches 208 are individually actuatable to control whether to pass one or more of the plurality of carriers. In some embodiments, the switch 108 comprises a bistable optical switch.

An optical interface 204 receives (and, if necessary, separates) the WDM signal 202 and the optical control signal 206 and directs these signals 202, 206 towards the components described below.

The apparatus 200 comprises a splitter 214 configured to direct the WDM signal 202 along a plurality of signal paths. Each signal path comprises a different one of the plurality of switches 208. The splitter 214 may comprise a fiber optic-based optical splitter that splits the WDM signal 202 evenly into N signal paths (the number, N, corresponding to the number of switches 208).

The apparatus 200 further comprises a plurality of optical filters 216 (numbered 1, 2, . . . , N). Each optical filter 216 is configured to filter a different specified carrier of the WDM signal 202. The optical filter 216 is configured to direct the specified carrier along one of the plurality of signal paths that is dedicated to carrying the specified carrier via the switch 208 of the signal path.

The apparatus 200 further comprises a combiner 218 configured to combine one or more of the plurality of carriers passed by the plurality of switches 208. The switch 208 of the signal path is configured to control whether to allow the carrier carried by the signal path to pass to the combiner 218.

Thus, each signal path has its own filter 216 and switch 208. The switch 208 is dedicated to controlling whether to pass the carrier signal admitted along the signal path by the optical filter 216. That is, the optical filter 216 may be configured to admit one carrier signal and substantially attenuate the remaining carrier signals of the WDM signal 202. Each of the N optical filters 216 is configured to admit a different one of the carrier signals and attenuate the remaining carrier signals. In this manner, each carrier signal can be separated from the other carrier signals and the switch 208 dedicated to each respective carrier signal may control whether the carrier signal is to be passed (e.g., by controlling the attenuation exhibited by the switch 208). The splitting/combining scheme of the splitter 214 and combiner 218 may be associated with a high optical insertion loss due to the use of fixed optical filters 216 in this scheme.

In some embodiments, the apparatus 200 provides a tunable filter constructed from a cascade of fixed optical filters 216 and passive bi-stable optical micro-mechanic switches 208.

The apparatus 200 may be considered to be passive in the sense that the apparatus 200 does not need any external electrical connection for providing power or control. Instead, electrical power and a management connection (for configuring the plurality of switches 208) is derived from the optical control signal 206 itself.

The insertion loss of switch 208 itself may be very low when the switch 208 is actuated to have a low attenuation to pass the carrier (e.g., less than 1 dB). However, as highlighted above, the insertion losses of the splitter 214 and combiner 218 combination may become high. In this case, an external or internal Semiconductor Optical Amplifier (SOA) or Erbium Doped Fiber Amplifier (EDFA) may be provided in conjunction with the apparatus 200 to recover the optical losses.

The apparatus 200 further comprises control circuitry 212. Some components of the control circuitry 212 are described. Not all components may be needed and/or the components may be configured in a different manner to that depicted by FIG. 2.

The control circuitry 212 comprises an Optical/Electrical (O/E) interface 220. For example, the O/E interface 220 may comprise a photovoltaic cell (or other appropriate semiconductor technology) configured to convert the optical power of the optical control signal 206 to electrical power. The CW component of the optical control signal 206 may be converted to a CW electrical signal for providing electrical power for the apparatus 200. This electrical power may be used for several purposes, as described herein.

In this embodiment, the control circuitry 212 comprises energy storage 222 (such as a battery, capacitor, etc.). The electrical power converted from the optical control signal 206 is stored in the energy storage 222. Thus, the electrical power may be used to charge the energy storage 222 until this stored energy required for use by the apparatus 200.

In some embodiments, the electrical power may directly power the apparatus 200 without being stored by such an energy storage 222.

The use of the electrical power derived from the optical power of the optical control signal 206 may facilitate powering of the apparatus 200 without needing to deploy an external electrical power source with the apparatus 200. An external electrical power source may need to be charged on a regular basis or replaced by a servicer, which may not be considered to be a passive activity.

The control circuitry 212 further comprises a decoder 224 to decode the encoding of the optical control signal 206 to extract the control information. The O/E interface 220 is configured to extract the encoded component of the optical control signal 206 as well as the CW component. Thus, the modulation depth and frequency of the encoded component is sufficient to allow extraction of the encoded component for the given type of technology employed by the O/E interface 220. For example, a photovoltaic cell may generate a modulated electrical signal with a suitable modulation depth that corresponds to the control information provided in the optical control signal 206. The encoded component may be extracted by an electrical filter (in or provided in conjunction with the O/E interface 220) at a specified frequency or frequency range so that the control information can be extracted.

The control circuitry 212 further comprises a processor 226 such as a microcontroller to, for example, interpret the control information and otherwise manage the functionality of the control circuitry 212 (such as how and when to charge the energy storage 222 or derive electrical from the energy storage 222). The processor 226 may comprise logic (e.g., hard-wired circuitry) or otherwise have access to machine-readable instructions stored in a memory (not shown) to implement the functionality of the processor 226. For example, instructions stored in the memory may, when executed by the processor 226, implement the functionality described above.

The control circuitry 212 further comprises a driver 228. The driver 228 is configured to control the state of the plurality of switches 208 via an electrical control signal 210 to individually actuate each of the switches 208 as needed and in accordance with the control information. The driver 228 is communicatively coupled to the processor 226 so that the processor 226 can provide the control information to the driver 228 or otherwise instruct the driver 228 to generate the electrical control signal 210. For example, the electrical control signal 210 may be generated by the processor 226 and provided to the driver 228 or the driver may itself generate the electrical control signal 210. The driver 228 is also electrically coupled to the energy storage 222 to derive the electrical power needed for actuating the plurality of switches 208. However, in some cases, the driver 228 may derive this electrical power directly from the O/E interface 220 as it receives optical power via the optical control signal 206.

The configuration of the components in the control circuitry 212 may vary. For example, although the decoder 224 and processor 226 are depicted as separate components, in some cases, they may form part of the same component. Further, although the processor 226 and driver 228 are depicted as separate components, in some cases, they may form part of the same component.

A controller 230 that is remote to the apparatus 200 is configured to provide the optical control signal 206 via an optical network between the controller 230 and the apparatus 200.

A fronthaul network 232 provides the WDM signal 202 and, in some cases, may use the same optical network as the optical control signal 206.

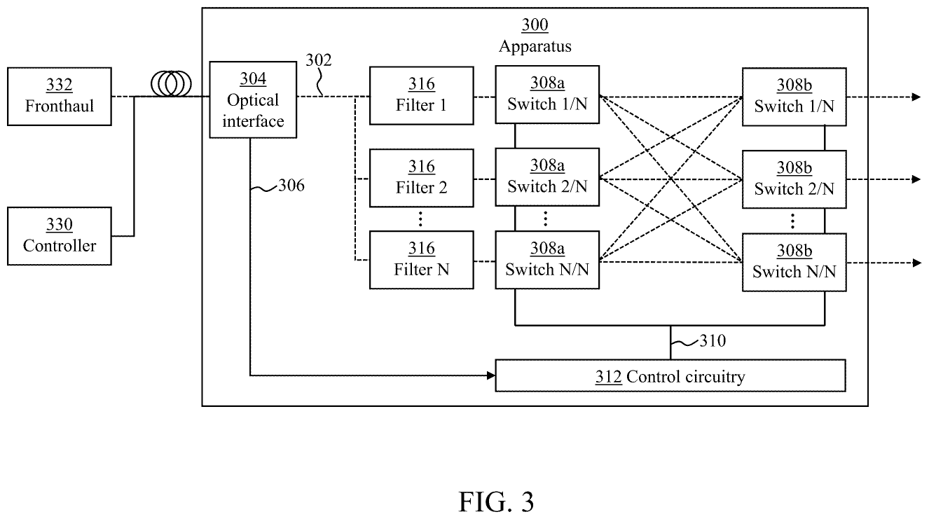

FIG. 3 is a schematic diagram illustrating an apparatus 300 for configuring carrier selection from a WDM signal 302 according to an embodiment. Reference signs for features of the apparatus 300 that are like or similar to corresponding features of the apparatus 200 are incremented by 100. A detailed description of such features is not provided for brevity. The features and functionality of the apparatus 300 are described in more detail below. As discussed above, the apparatus 300 may be a telecommunications network node, which is for example for use in a fronthaul optical network in a radio access network.

The apparatus 300 comprises plurality of switches 308. Similar to above, the plurality of switches 308 are individually actuatable to control whether to pass one or more of the plurality of carriers.

An optical interface 304 receives (and, if necessary, separates) the WDM signal 302 and the optical control signal 306 (from the fronthaul 332 and controller 330, respectively) and directs these signals 302, 306 towards the components described below.

The apparatus 300 comprises a plurality of optical filters 316 (numbered 1, 2, . . . , N). Each optical filter 316 is configured to filter a different specified carrier of the WDM signal 302 The optical filter 316 is configured to direct the specified carrier along one of a plurality of signal paths that is dedicated to carrying the specified carrier.

The plurality of switches 308 comprises a first set of switches 308a (numbered 1, 2, . . . , N). Each of the first set of switches 308a is coupled to a different one of the plurality of signal paths.

The plurality of switches 308 comprises a second set of switches 308b (numbered 1, 2, . . . , N). Each of the second set of switches 308b is communicatively coupled to each of the first set of switches 308a to allow any one of the first set of switches 308a to communicate its specified carrier to any one of the second set of switches 308b. That is, each of the first set of switches 308a has multiple signal paths and each of the multiple signal paths is communicatively coupled to each of the second set of switches 308b. In this manner, the carrier passed by one of the first set of switches 308a can be directed to any of the second set of switches 308b, which may itself select whether to pass any carriers it receives (from any of the first set of switches 308a).

The optical filters 316 may be considered to be daisy-chained in that each optical filter 316 is configured to admit a different one of the carriers of the WDM signal 302 (to the switch 308a dedicated to the admitted carrier) and direct the non-admitted carriers of the WDM signal 302 to the next optical filter 316 in the chain. For example, thin film filter technology may be deployed to admit a carrier of a specified wavelength band and redirect the remaining carriers in the other wavelength bands towards the other optical filters 316 in the chain.

In this manner, the carriers of the WDM signal 302 are efficiently filtered such that a different carrier is directed towards each switch 308a that is dedicated to the carrier. The first and second sets of switches 308a, 308b form an optical matrix to allow redirecting of a carrier along the multiple possible signal paths associated with the second set of switches 308b. In some embodiments, the plurality of switches 308 may be implemented using micromechanical optical latched (multi-stable) switches. The implementation of the optical matrix may vary according to need. For example, there may not be a need for every carrier to be redirectable to every available switch of the second set of switches 308b.

In some embodiments, the optical insertion loss is very low e.g., where thin filter technology is used by the chained optical filters and multi-stable optical switch micro-mechanicals are used by the switches 308.

The apparatus 300 further comprises control circuitry 312 (e.g., with the same functionality as the control circuitry 212 of FIG. 2). The control circuitry 312 is communicatively coupled to the plurality of switches 308 to provide each switch 308 with the electrical control signal 310 when needed to change the state of the switch 308 based on the control information provided with the optical control signal 306.

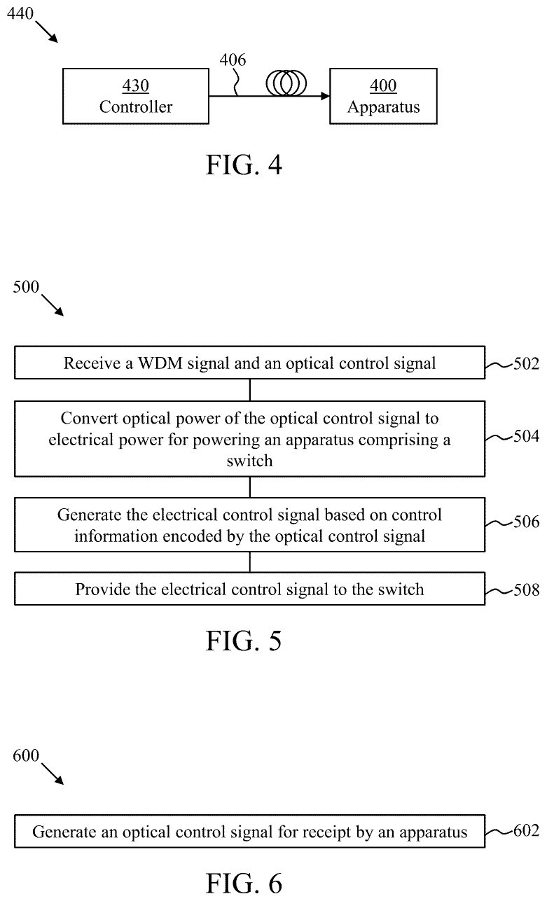

FIG. 4 is a schematic diagram illustrating a system 440 comprising an apparatus 400 and a controller 430 for controlling a configuration of the apparatus 400 according to an embodiment. The apparatus 400 may comprise the apparatus 100, 200 or 300, or any related embodiments. The controller 430 may comprise the controller 230 or 330, as referred to above. Further details of the controller 430 are provided below. Not all features of the apparatus 400 are shown for brevity. Therefore, for ease of reference, the following description of the system 440 also refers to features in FIG. 1.

The controller 430 configures carrier selection, by the apparatus 400, from a WDM signal 102 comprising a plurality of carrier signals. The controller 430 is configured to generate an optical control signal 406 for receipt by the apparatus 400. The optical control signal 406 is configured to allow the apparatus 400 to convert optical power of the optical control signal 406 to electrical power for powering the apparatus 400. The optical control signal 406 is encoded with control information for controlling a switch 108 of the apparatus 400 to control carrier selection according to whether the switch 108 is to pass a carrier of the WDM signal 102 through the switch 108.

By being configured to allow the apparatus 400 to convert optical power of the optical control signal 406 to electrical power for powering the apparatus 400, the optical control signal may have sufficient optical power that can be converted to electrical power to power the apparatus. For example, the optical power of the optical control signal 406 generated by the controller 430 may be sufficient to overcome the losses of the optical network and within the apparatus 400 itself so that the control circuitry 112 can extract sufficient electrical power to power the apparatus 400.

FIG. 5 is a flowchart of a method 500 of configuring carrier selection from a WDM signal according to an embodiment. The following description of the method 500 refers to functionality of the apparatus 100 of FIG. 1, to which reference is made, although this functionality is also relevant to other apparatus described herein such as the apparatus 200, 300, 400.

The method 500 comprises, at block 502, receiving a WDM signal 102 and an optical control signal 106.

The method 500 comprises, at block 504, converting optical power of the optical control signal 106 to electrical power for powering an apparatus 100 comprising a switch 108. The switch 108 is actuatable in response to an electrical control signal 110 to control carrier selection according to whether the switch 108 is to pass a carrier of the WDM signal 102. The optical control signal 106 is encoded with control information for controlling the switch 108.

The method 500 comprises, at block 506, generating the electrical control signal 110 based on the control information.

The method 500 comprises, at block 508, providing the electrical control signal 110 to the switch 108.

FIG. 6 is a flowchart of a method 600 of controlling a configuration of an apparatus (such as apparatus 100, 200, 300) for configuring carrier selection from a WDM signal according to an embodiment. The following description of the method 600 refers to functionality of the controller 430 of FIG. 4. For ease of reference, further reference is made to features of the apparatus 100 of FIG. 1.

The method 600 comprises, at block 602, generating an optical control signal 106 for receipt by the apparatus 400. The optical control signal 106 is configured to allow the apparatus 100 to convert optical power of the optical control signal 106 to electrical power for powering the apparatus 100. The optical control signal 106 is encoded with control information for controlling a switch 108 of the apparatus 100 to control carrier selection according to whether the switch 108 is to pass a carrier of the WDM signal 102 through the switch 108.

Any element or functionality of a described embodiment may be combined with or replace a corresponding element or functionality of another described embodiment.

A processor (which includes one or more processors) may include a central processing unit (CPU), application specific integrated circuit (ASIC), field programmable gate array (FPGA) or the like. A memory may include one or several types of memory suitable for the processor, such as read-only memory (ROM), random-access memory, cache memory, flash memory devices, optical storage devices, solid state disk, hard disk drive, etc.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

The above-described embodiments are intended to be examples only. Alterations, modifications and variations may be effected to the particular embodiments by those of skill in the art without departing from the scope of the description, which is defined solely by the appended claims.

1. Apparatus for configuring carrier selection from a wavelength-division multiplexed, WDM, signal comprising a plurality of carriers, and wherein the apparatus comprises:
an optical interface, wherein the optical interface is configured to receive the WDM signal and an optical control signal;
a switch, wherein the switch is actuatable in response to an electrical control signal to control carrier selection according to whether the switch is to pass a carrier of the WDM signal; and
control circuitry, wherein the control circuitry is configured to:
convert optical power of the optical control signal to electrical power for powering the apparatus, wherein the optical control signal is encoded with control information for controlling the switch;
generate the electrical control signal based on the control information; and
provide the electrical control signal to the switch.

2. The apparatus of claim 1, wherein the WDM signal and the optical control signal are received via a common input to the optical interface.

3. The apparatus of claim 1, wherein the switch has a first state and a second state, wherein:
in the first state, the switch is configured to prevent the carrier from passing the switch; and
in the second state, the switch is configured to permit the carrier to pass the switch.

4. The apparatus of claim 3, wherein in use of the apparatus, no electrical power is consumed by the switch when in the first state or the second state, and wherein electrical power is consumed by the switch when switching between the first and second states.

5. The apparatus of claim 1, wherein the switch comprises a latched switch.

6. The apparatus of claim 1, wherein the electrical power is derived from a continuous wave component of the optical control signal.

7. The apparatus of claim 1, comprising a plurality of switches, wherein the plurality of switches are individually actuatable to control whether to pass one or more of the plurality of carriers.

8. The apparatus of claim 7, comprising:
a splitter configured to direct the WDM signal along a plurality of signal paths, wherein each signal path comprises a different one of the plurality of switches;
a plurality of optical filters, wherein each optical filter is configured to filter a different specified carrier of the WDM signal, and wherein the optical filter is configured to direct the specified carrier along one of the plurality of signal paths that is dedicated to carrying the specified carrier via the switch of the signal path; and
a combiner configured to combine one or more of the plurality of carriers passed by the plurality of switches, wherein the switch of the signal path is configured to control whether to allow the carrier carried by the signal path to pass to the combiner.

9. The apparatus of claim 8, wherein the switch comprises a bistable optical switch.

10. The apparatus of claim 7, comprising:
a plurality of optical filters, wherein each optical filter is configured to filter a different specified carrier of the WDM signal, and wherein the optical filter is configured to direct the specified carrier along one of a plurality of signal paths that is dedicated to carrying the specified carrier;
a first set of switches, wherein each of the first set of switches is coupled to a different one of the plurality of signal paths; and
a second set of switches, wherein each of the second set of switches is communicatively coupled to each of the first set of switches to allow any one of the first set of switches to communicate its specified carrier to any one of the second set of switches.

11. The apparatus of claim 1, wherein the control circuitry comprises energy storage, wherein the electrical power converted from the optical control signal is stored in the energy storage.

12. A controller for controlling a configuration of an apparatus for configuring carrier selection from a wavelength-division multiplexed, WDM, signal comprising a plurality of carriers, wherein the controller is configured to:
generate an optical control signal for receipt by the apparatus, wherein the optical control signal is configured to allow the apparatus to convert optical power of the optical control signal to electrical power for powering the apparatus, and wherein the optical control signal is encoded with control information for controlling a switch of the apparatus to control carrier selection according to whether the switch is to pass a carrier of the WDM signal through the switch.

13. A system, comprising:
the controller of claim 12; and
an apparatus for configuring carrier selection from a wavelength-division multiplexed, WDM, signal comprising a plurality of carriers, and wherein the apparatus comprises:
an optical interface, wherein the optical interface is configured to receive the WDM signal and an optical control signal;
a switch, wherein the switch is actuatable in response to an electrical control signal to control carrier selection according to whether the switch is to pass a carrier of the WDM signal; and
control circuitry, wherein the control circuitry is configured to:
convert optical power of the optical control signal to electrical power for powering the apparatus, wherein the optical control signal is encoded with control information for controlling the switch;
generate the electrical control signal based on the control information; and
provide the electrical control signal to the switch.

14. A method of configuring carrier selection from a wavelength-division multiplexed, WDM, signal comprising a plurality of carriers, wherein the method comprises:
receiving the WDM signal and an optical control signal;
converting optical power of the optical control signal to electrical power for powering an apparatus comprising a switch, wherein the switch is actuatable in response to an electrical control signal to control carrier selection according to whether the switch is to pass a carrier of the WDM signal, and wherein the optical control signal is encoded with control information for controlling the switch;
generating the electrical control signal based on the control information; and
providing the electrical control signal to the switch.

15. A method of controlling a configuration of an apparatus for configuring carrier selection from a wavelength-division multiplexed, WDM, signal comprising a plurality of carriers, wherein the method comprises:
generating an optical control signal for receipt by the apparatus, wherein the optical control signal is configured to allow the apparatus to convert optical power of the optical control signal to electrical power for powering the apparatus, and wherein the optical control signal is encoded with control information for controlling a switch of the apparatus to control carrier selection according to whether the switch is to pass a carrier of the WDM signal through the switch.
